(19) United States
(12) Patent Application Publication
(10) Pub. No.: US 2005/0196584 A1
(43) Pub. Date: Sep. 8, 2005

(54) Continuous support interleaving

(75) Inventors: Thomas J. Halecki, Rochester, NY (US); Phillip H. Blank, Spencerport, NY (US); Kevin A. Cole, Ontario, NY (US); Thomas Asenato JR., Rochester, NY (US); Charles P. Elberti, Rochester, NY (US); Mitchell S. Burberry, Webster, NY (US); George T. McCollough, Penfield, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/795,897

(22) Filed: Mar. 8, 2004

(51) Int. Cl. B32B 3/06

(52) U.S. Cl. 428/100

(57) ABSTRACT

The present invention relates to a method of interleaving a support comprising providing a support, applying a curable material to a side of the support, applying an interleaving material to the support so as not to be in contact with the curable material, and winding the support to produce a continuous gap between the side of the support opposite the coated side of the support. The present invention also includes a roll of liquid crystalline material comprising a support having thereon a curable material and an interleaving material, wherein the interleaving material is not in contact with the curable material on the support, and wherein the support is wound to form a roll.

### FIELD OF THE INVENTION

The present invention relates to use of interleaving materials in flexible supports.

### BACKGROUND OF THE INVENTION

In the manufacture of coated or printed articles, such as LCDs, it is desirable that the coated or printed layers be fully cured, if they are to be in contact with other materials after coating or printing, to avoid the printed layer sticking to these other materials which may further result in blocking, an undesired transfer of the coated or printed material onto the other material. Complete curing is especially desirable when the coated or printed materials are wound into a roll form after printing. The uncured material can stick to the previous lap of rolled material and the entire roll can become unusable. Curing is typically accomplished by drying to remove solvents or photoinitiation of a hardening process or both.

A liquid crystal display (LCD) is a type of flat panel display used in various electronic devices. At a minimum, an LCD comprises a support, such as glass or plastic, at least one conductive layer and a liquid crystal layer. LCDs may also be more complex and have additional components. For example, an LCD may comprise a transparent, multilayer flexible support, coated with a first patterned conductive layer and coated with a light-modulating liquid crystal layer. A second conductive layer is applied and overcoated with a dielectric layer to which dielectric conductive row contacts are attached, including via that permit interconnection between conductive layers and the dielectric conductive row contacts. Other optional functional layers may be applied between the various layers.

The manufacture of display articles in a continuous fashion is of great interest for the purpose of providing low cost and flexible displays. U.S. Pat. No. 6,394,870 describes a liquid crystal display comprising a cholesteric liquid crystal layer disposed on a conductive layer on a flexible support, with a second conductor which is screen printed in a pattern over the liquid crystal layer. Screen printed dielectric materials and additional conductive materials are further described. It is desirable to wind the liquid crystal coated flexible support after a screen-printing operation is completed. However the screen-printed materials cannot come in contact with other material prior to full curing. Also, cholesteric liquid crystals can be pressure sensitive, such that uneven pressure in the wound roll can cause undesirable and perhaps irreversible transitioning of the liquid crystal.

U.S. Pat. No. 4,172,160 describes providing a protective coating to a bare or prepainted metal support. The protective coating reduces or eliminates the possibility of damage to the support or any other coatings that may be applied to the support prior to the addition of the protective coating. However, such coatings do not allow for air flow for curing of applied materials, for example, coated or printed materials, to be completed, by allowing for solvents or gaseous by-products of hardening reactions to escape the roll. Also, the protective coating is in contact with the precoated layer such that blocking may occur when the materials are wound together in a roll format.

U.S. 2002/0176988 describes a protective material and coating applied to temporarily protect a flat or curved substrate during shipping, handling and transport, that is, the protective material is wound together with the coated roll in laps of alternating coated material and protective material. However, such interleaving does not allow for air flow for curing of later applied materials, such as coated or printed materials, to be completed, by allowing for solvents or gaseous by-products of hardening or curing reactions to escape the roll. Also, the interleaving material is in contact with the coated layer and blocking may occur when the materials are wound together in a roll format.

U.S. Pat. No. 6,653,165 describes the winding of the substrate of a semiconductor element with a protective material between the roll laps to prevent the production of flaws on the substrate. The protective material is preferably a paper-like interleaving material which allows the substrate to be kept in close fit with the protective material. However such interleaving material may contact the coated layer upon winding, resulting in unacceptable pressure damage to the coating and may cause blocking between the coating and the interleaving paper. Also the interleaving does not allow airflow through the roll, which may be used to fully cure by allowing solvents or gaseous by-products of curing to escape the roll after it has been wound.

U.S. Pat. No. 6,366,013 describes an anti-reflective coating provided on a web or sheet-like material, specifically, a flexible glass substrate. The anti-reflective material of the invention may be provided as a web wound up on a roll or may be cut in sheets. When supplied as sheets, an interleaf is provided as a protective sheet or spacer between two consecutive anti-reflective sheets. When supplied as a roll, a web interleaf is wound up on the roll together with the anti-reflective material. However, the interleaf material is in direct contact with the substrate, which could result in blocking of any coated layers and damage to the coatings on adjacent laps due to pressure sensitivity. Also, the interleaf material does not provide a method to allow the escape of gas or gaseous by-products of the curing of other coatings on the substrate.

GB 916,863 describes an improved way to emboss a fabric substrate. The embossing fabric, the fabric to be embossed and a thick interleaf blanket of felted cotton are wound tightly on to a perforated roller, and steam passes through the roller by way of the perforations. However, the interleaf material is in intimate contact with the support, which may cause scratching, blocking and pressure damage when wound. Also, the steam is introduced in the radial direction such that only one lap of the roll is affected by the steam.

U.S. 2003/0205314 describes a process to extrude plastics. The surface of a film is embossed with a finish, is cooled, and the cooled thermoplastic sheet is collected on a roll or cut using a single layer of interleaf material to separate consecutive wraps or layers. However, the interleaf material is in direct contact with the substrate, which may result in the blocking of any coated layers and pressure between adjacent laps, resulting in damage to the coatings themselves. Also, the interleaf material does not provide a method for the escape of any gas or gaseous by-products of curing once the roll has been wound.

### PROBLEM TO BE SOLVED

There remains a need to provide for the curing of materials, which have been applied to a substrate or support, by allowing air flow over the surface and allowing for solvents or gaseous by-products of the curing reactions to escape the roll, and to provide the for protection of coated or printed materials against scratching and blocking. There is further a need to protect pressure sensitive materials applied to the substrate from the effects of pressure when wound.

### SUMMARY OF THE INVENTION

The present invention relates to a method of interleaving a support comprising providing a support, applying a curable material to a side of the support, applying an interleaving material to the support so as not to be in contact with the curable material, and winding the support to produce a continuous gap between the side of the support opposite the coated side of the support. The present invention also includes a roll of liquid crystalline material comprising a support having thereon a curable material and an interleaving material, wherein the interleaving material is not in contact with the curable material on the support, and wherein the support is wound to form a roll.

### ADVANTAGEOUS EFFECT OF THE INVENTION

The present invention includes several advantages, not all of which are incorporated in a single embodiment. The new concept may provide contact around the circumference of the roll. Interleaving according to the present invention provides continuous, potentially uniform interlayer gaps radially and axially through a wound roll. The interleaving provides a channel for air to flow through freely between the curable coating on the support and prohibiting any interlayer contact, so that proper curing is possible within the roll. This is a desirable feature that can be used to mitigate the effects of blocking, that is, molecular transfer between adjacent layers in very intimate contact. The interleaving material also relieves pressure in the wound, interleaved support to avoid any deleterious effects resulting from pressure sensitivity of the curable coating. Interleaving material is clean for use in manufacturing, reusable, and low in cost.

### BRIEF DESCRIPTION OF THE DRAWINGS

FIG. 1 is a cross sectional view, not to scale, of the wound support, coating on the support and the interleaving material. This view represents the interaction of the support, its coatings and the interleaving.

FIG. 2 is the test setup, not to scale, used to investigate the feasibility of this invention.

FIG. 3 is a representation, not to scale, of the locations at which air flow measurements were taken on the wound interleaved roll.

FIG. 4 is a schematic of the process flow of the manufacturing of coated substrate.

FIG. 5 is a representation, not to scale, of the mesh used as an interleaving material

FIG. 6 represents a wound roll package useful with the present invention.

### DETAILED DESCRIPTION OF THE INVENTION

The present invention relates to a method of providing a support, applying a curable material to at least one side of the support, applying an interleaving material to the support so as not to be in contact with the curable material applied to the support, and winding the support to produce a uniform or at least continuous gap between the curable material and the side of the support opposite the side of the support coated with the curable material. The interleaving material provides a continuous gap to enable complete curing of the printed material, pressure relief in the wound roll, and which minimizes any waste that may occur due to pressure damage and blocking. The present invention relates to the continuous manufacture of printed articles where the printed material requires curing. The present invention is particularly useful in continuous or roll-to-roll manufacture of displays articles.

The goal of the interleaving is to provide a continuous gap in between all adjacent laps in a wound roll. This is done for two primary reasons. First, the use of curable coatings on the support prohibits any interlayer contact to occur so that proper curing is possible. Since the coatings cure, the interleaving allows air to be blown through the wound roll freely or allow natural venting of air or gaseous by-products. This is a desirable feature that may be used to mitigate the effects of blocking, a molecular transfer between adjacent layers in very intimate contact. Secondly, the interleaving relieves pressure on the interleaved support. For purposes of the present invention, a gap is considered continuous if lapped layers of the support are not in direct and intimate contact with each other resulting in blocking and the gap is sufficient to allow curing, either through contact with air or other gas or through adequate escape of curing by-products.

Interleaving has been developed that provides a continuous gap between adjacent laps in a wound roll that provides in-roll venting. The interleaving provides a channel for air to pass freely either by forcing air through or natural air flow. This interleaving also provides support for lap separation in the roll. The interleaving material is reusable and clean. This technology may be practical for new products that need separation of laps in roll-to-roll manufacturing.

Various materials may be used as interleaving materials. The interleaving material provides a channel for air to pass freely through. Preferably, the interleaving material is in the form of a continuous roll and is continuously applied to the support. The applied interleaving material may also be removed from the support, once the interleaved roll is unwound, thereby facilitating reuse.

The interleaving material may have a variety of configurations. In one preferred embodiment, the interleaving material has a width that is less than or equal to the distance from the edge of the support to the printed material. Preferably, at least two rolls of interleaving material are used to support each edge of the wound roll, but one roll may be used along only one edge of the support or on the support in a location other than an edge, but not in contact with the coating, provided that the support is stiff enough to maintain the gap created by the interleaved material without sagging on the unsupported edge.

The interleaving material is most desirably a flexible material. The interleaving material may be made of natural fibers, synthetic fibers, extruded synthetic materials, metals and the like. The interleaving material may be a textile produced from natural fibers. Porous foam may be used as interleaving material. The porosity of open-cell foam may allow air to be blown between layers. The foam may provide a continuous support throughout the roll and there is no pattern in this material to allow adjacent laps to come into phase and mesh together. In one embodiment, two strips of thin porous foam may be interleaved into the wound roll.

Bubble wrap may also be used as interleaving material. This product is a cheap, readily available solution to providing support in an interleaved roll. There are gaps in between the air pockets, which allow air to be blown through. The outside layers are thin sheets of plastic with the middle layer containing the actual bubbles.

Velcro® fastener material may also be used as interleaving material. The hook component of Velcro® fastener material provides a continual separator and cushion for the support and also allows air flow through it without a significant pressure drop across the strips. The Velcro® fastener material has enough stiffness that the hooks are not crushed under pressure. This is a desirable feature as the rolls are wound. Higher winding tensions generally lead to higher in-roll pressure. Since the Velcro® fastener material minimally compresses, higher winding tensions may be used to wind the roll, resulting in a tighter wound roll.

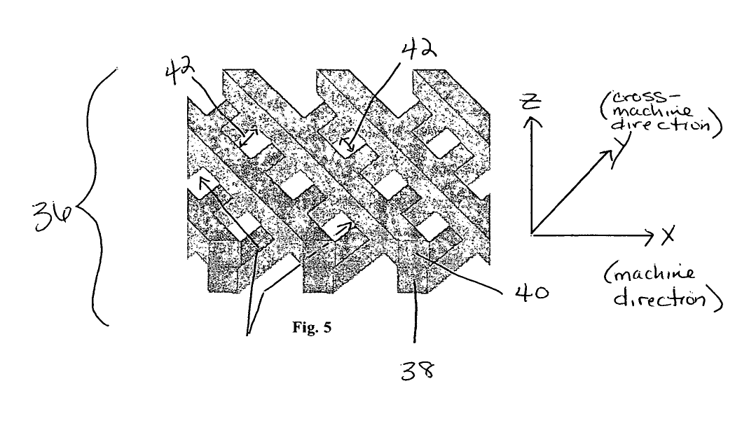

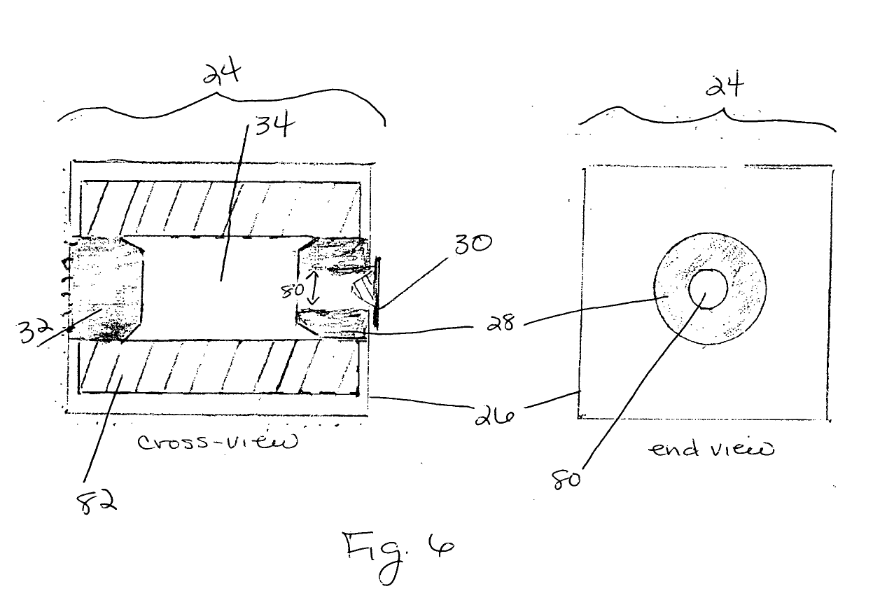

Mesh materials may also be used to interleave the support. Plastic mesh materials are of particular interest. The mesh may be an extruded plastic and bi-planar in nature, as shown in FIG. 5. In one embodiment, strips of polymer mesh are interleaved onto the edges of a roll. Bi-planar refers to any mesh that, when manufactured, forms channels that may be used to allow gas or liquid flow. Typically, the mesh is two extruded layers of polymer, which has cross-member layers of polymer which are not in the same x-y plane. As shown in FIG. 5, member 38 and cross-member 40, when combined, form a polymeric mesh material 36 having channels 42 to allow flow. The bi-planar nature of the mesh will allow air to be blown through a roll. In a preferred embodiment, the mesh may be slit down to strips and wound into the roll, as with the Velcro® fastener interleaving. Types of mesh material suitable for use in the invention are polypropylene meshes, such as XN-4510, at 96 lbs/1000 ft², and XN-4410, at 40 lbs/1000 ft², made by InterNet Incorporated, Minneapolis, Minn. Various types of mesh configurations are available. Mesh that is commercially available can have a wide range of thickness. The mesh may be thick enough that it can withstand distortions caused by winding tensions at which it will be conveyed. However, the thicker the mesh, the larger the wound roll produced, which is harder to deal with in a production setting. As the thickness of the material will play a significant role in the size of the wound roll, the appropriate thickness for the interleaving materials is preferably determined, based on the final end use and manufacturing requirements.

Various types of interleaving configurations are available. Interleaving material is commercially available in a wide range of thicknesses. The interleaving material may be of any thickness, which allows the formation of a continuous gap in a wound roll. The interleaving material desirably produces a continuous gap of greater than 75 microns, more preferably from 0.127 mm to 3.175 mm (5 mils to 125 mils). Preferably the gap is sufficient to allow an air flow, created by pumping air through the gap, of from greater than 0 to 269 mpm (0 to 880 fpm) in velocity. The preferred range of thickness for the interleaving material for use in liquid crystalline display production is in the range of 0.762 mm to 2.286 mm (30-90 mils), such as Velcro fastener material at approximately 1.524 (60 mils) in thickness, and plastic mesh interleaving material at approximately 1.016 mm to 2.032 mm (40 mils or 80 mils) in thickness.

The interleaving material may include an adhesive backing. The adhesive is advantageous to enhance and speed up different winding conditions, primarily winding tension. Unwinding and winding may be simplified, since the interleaving material becomes one with the support. In one embodiment, the interleaving material may be adhered to a second support, which, when in use, is in contact with the backside or uncoated side of the printed support.

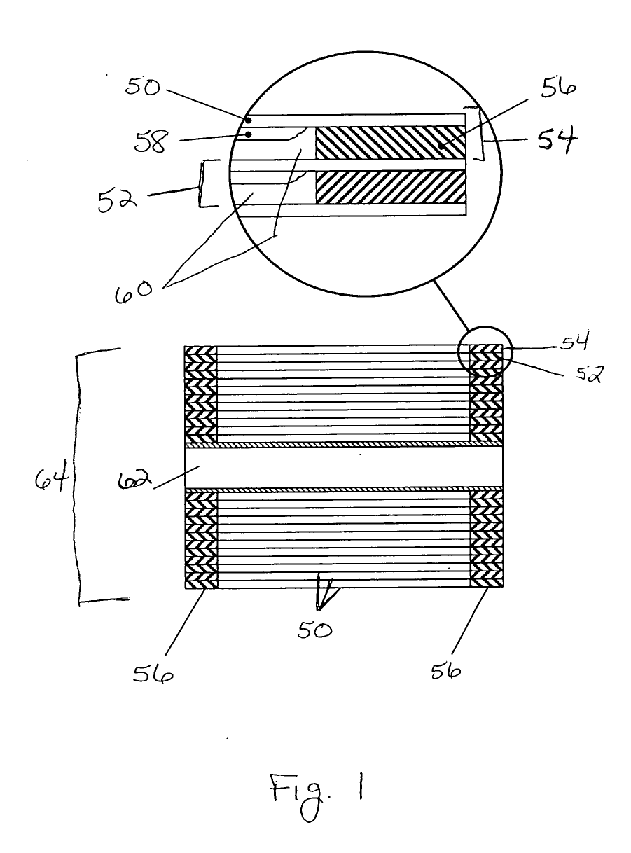

In simplest form, the interleaving material is interleaved with a windable support. The support may be made of a flexible material, preferably a flexible polymeric material such as Kodak Estar film base formed of polyester plastic. Preferably, the thickness of the support is at least 3 microns, and more preferably, from 50 to 250 microns or approximately 2-10 mils. For example, the support may be an 80 microns thick sheet of transparent polyester. The thickness of the support and curable material layers may vary but are most preferably in the range from 60 to 300 microns, with the thickness of the curable layers in the range of from 10 to 70 microns. A preferred embodiment of a wound roll according to the invention is illustrated in FIG. 1 as a lengthwise cross sectional view of an exemplary wound roll. Curable coating 58 is applied to windable support 50, wound on a core 62. Interleaving material 56 is applied to support 50, prior to, during or after the application of curable coating 58, but prior to winding. The coated support is then wound to form wound roll 64, containing multiple consecutive laps, such as lap 1 (52) and lap 2 (54). A gap 60 is produced by interleaving material 56, which keeps curable coating 58 from contacting windable support 50.

The flexible plastic support may be any flexible self-supporting plastic film. “Plastic” means a high polymer, usually made from polymeric synthetic resins, which may be combined with other ingredients, such as curatives, fillers, reinforcing agents, colorants, and plasticizers. Plastic includes thermoplastic materials and thermosetting materials.

The flexible plastic film preferably has sufficient thickness and mechanical integrity so as to be self-supporting, yet may not be so thick as to be rigid. Typically, the flexible plastic support is the thickest layer of a composite film in thickness. Consequently, the support determines to a large extent the mechanical and thermal stability of the fully structured composite film.

Another significant characteristic of a flexible plastic support material is its glass transition temperature (Tg). Tg is defined as the glass transition temperature at which plastic material will change from the glassy state to the rubbery state. It comprises a range before the material may actually flow. Suitable materials for the flexible plastic support include thermoplastics of a relatively low glass transition temperature, for example up to 150° C., as well as materials of a higher glass transition temperature, for example, above 150° C. The choice of material for the flexible plastic support may depend on various factors, for example, manufacturing process conditions, such as deposition temperature, and annealing temperature, as well as those conditions encountered post-manufacturing, such as in a process line of a display manufacturer. Certain of the plastic supports discussed below can withstand higher processing temperatures of up to at least 200° C., some up to 300-350° C., without damage.

Typically, the flexible plastic support is polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl (x-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA). Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic support is a cyclic polyolefin or a polyester. Various cyclic polyolefins are suitable for the flexible plastic support. Examples include Arton® made by Japan Synthetic Rubber Co., Tokyo, Japan; Zeanor T made by Zeon Chemicals L.P., Tokyo Japan; and Topas® made by Celanese A. G., Kronberg Germany. Arton® is a poly(bis(cyclopentadiene)) condensate that is a film of a polymer. A preferred polyester is an aromatic polyester such as Arylite. Although various examples of plastic supports are set forth above, it may be appreciated that the support may also be formed from other materials such as glass and quartz, providing they are flexible.

The flexible plastic support may be reinforced with a hard coating. Typically, the hard coating is an acrylic coating. Such a hard coating typically has a thickness of from 1 to 15 microns, preferably from 2 to 4 microns and may be provided by free radical polymerization, initiated either thermally or by ultraviolet radiation, of an appropriate polymerizable material. Depending on the support, different hard coatings may be used. When the support is polyester or Arton®, a particularly preferred hard coating is the coating known as “Lintec.” Lintec contains UV-cured polyester acrylate and colloidal silica. When deposited on Arton®, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wisconsin.

In the present invention, curable materials are applied to the support. The curable material may comprise any material that is curable and may be applied to form a coating. This may include materials that may require some chemical mechanism, such as crosslinking, to cure as well as evaporation of a carrier solvent. In one embodiment, the curable material may comprise a polymeric material. Coatings may include, but are not limited to, imageable layers, light modulating layers, conductive layers, color contrast layers, dielectric layers, and barrier layers. The curable material may be directly applied to the substrate or it may be applied with a carrier material that may be later removed to facilitate the curing process, such as a solvent.

The curable materials may be applied to the support by any method known by those of skill in the art to form a layer. Some exemplary methods may include screen printing, hopper coating, gravure printing, lithographic and photolithographic printing, spraying, and vapor depositing.

The curing process can occur by any means known to those of skill in the art of curing coatings, such as through application of light, heat, air flow, chemical reaction, or some other source of energy. Light activation of the curing process can occur through exposure to ultraviolet, visible, infrared light, or combinations thereof, which then initiates a chemical reaction to cure the materials, such as through cross-linking polymerizations.

In one embodiment, at least one imagable layer is applied to the support. The imageable layer can contain an electrically imageable material. The electrically imageable material can be light emitting or light modulating. Light emitting materials can be inorganic or organic in nature. Particularly preferred are organic light emitting diodes (OLED) or polymeric light emitting diodes (PLED). The light modulating material can be reflective or transmissive. Light modulating materials can be electrochemical, electrophoretic, such as Gyricon particles, electrochromic, or liquid crystals. The liquid crystalline material can be twisted nematic (TN), super-twisted nematic (STN), ferroelectric, magnetic, or chiral nematic liquid crystals. Especially preferred are chiral nematic liquid crystals. The chiral nematic liquid crystals can be polymer dispersed liquid crystals (PDLC). Structures having stacked imaging layers or multiple support layers, however, are optional for providing additional advantages in some case.

In a preferred embodiment, the electrically imageable material can be addressed with an electric field and then retain its image after the electric field is removed, a property typically referred to as “bistable”. Particularly suitable electrically imageable materials that exhibit “bistability” are electrochemical, electrophoretic, such as Gyricon particles, electrochromic, magnetic, or chiral nematic liquid crystals. Especially preferred are chiral nematic liquid crystals. The chiral nematic liquid crystals can be polymer dispersed liquid crystals (PDLC).

Most preferred is a support bearing a conventional polymer dispersed light-modulating material. The liquid crystal (LC) is used as an optical switch. The supports are usually manufactured with transparent, conductive electrodes, in which electrical “driving” signals are coupled. The driving signals induce an electric field which can cause a phase change or state change in the LC material, the LC exhibiting different light-reflecting characteristics according to its phase and/or state.

Liquid crystals may be nematic (N), chiral nematic (N*), or smectic, depending upon the arrangement of the molecules in the mesophase. Chiral nematic liquid crystal refers to the type of liquid crystal having finer pitch than that of twisted nematic and super-twisted nematic. Chiral nematic liquid crystals are so named because such liquid crystal formulations are commonly obtained by adding chiral agents to host nematic liquid crystals. Chiral nematic liquid crystals may be used to provide bistable and multistable reflective displays that, due to their non-volatile “memory” characteristic, do not require a continuous driving circuit to maintain a display image, thereby significantly reducing power consumption. Chiral nematic displays are bistable in the absence of a field, the two stable textures being the reflective planar texture and the weakly scattering focal conic texture. In the planar texture, the helical axes of the chiral nematic liquid crystal molecules are substantially parallel to the support upon which the liquid crystal is disposed. In the focal conic, state the helical axes of the liquid crystal molecules are generally randomly oriented. By adjusting the concentration of chiral dopants in the chiral nematic material, the pitch length of the molecules and, thus, the wavelength of radiation that they will reflect, may be adjusted. Chiral nematic materials that reflect infrared radiation have been used for purposes of scientific study. Commercial displays are most often fabricated from chiral nematic materials that reflect visible light. Some known LCD devices include chemically-etched, transparent, conductive layers overlying a glass substrate as described in U.S. Pat. No. 5,667,853, incorporated herein by reference.

There are alternative display technologies to LCDs that may be used, for example, in flat panel displays. A notable example is organic or polymer light-emitting devices (OLEDs) or (PLEDs), which are comprised of several layers in which one of the layers is comprised of an organic material that can be made to electroluminesce by applying a voltage across the device. An OLED device is typically a laminate formed in a substrate such as glass or a plastic polymer. A light-emitting layer of a luminescent organic solid, as well as adjacent semiconductor layers, are sandwiched between an anode and a cathode. The semiconductor layers may be whole-injecting and electron-injecting layers. PLEDs may be considered a subspecies of QLEDs in which the luminescent organic material is a polymer. The light-emitting layers may be selected from any of a multitude of light-emitting organic solids, e.g., polymers that are suitably fluorescent or chemiluminescent organic compounds. Such compounds and polymers include metal ion salts of 8-hydroxyquinolate, trivalent metal quinolate complexes, trivalent metal bridged quinolate complexes, Schiff-based divalent metal complexes, tin (IV) metal complexes, metal acetylacetonate complexes, metal bidenate ligand complexes incorporating organic ligands, such as 2-picolylketones, 2-quinaldylketones, or 2-(o-phenoxy) pyridine ketones, bisphosphonates, divalent metal maleonitriledithiolate complexes, molecular charge transfer complexes, rare earth mixed chelates, (5-hydroxy) quinoxaline metal complexes, aluminum tris-quinolates, and polymers such as poly(p-phenylenevinylene), poly(dialkoxyphenylenevinylene), poly(thiophene), poly(fluorene), poly(phenylene), poly(phenylacetylene), poly(aniline), poly(3-alkylthiophene), poly(3-octylthiophene), and poly(N-vinylcarbazole). When a potential difference is applied across the cathode and anode, electrons from the electron-injecting layer and holes from the hole-injecting layer are injected into the light-emitting layer; they recombine, emitting light. OLEDs and PLEDs are described in the following United States patents, all of which are incorporated herein by this reference: U.S. Pat. No. 5,707,745 to Forrest et al., U.S. Pat. No. 5,721,160 to Forrest et al., U.S. Pat. No. 5,757,026 to Forrest et al., U.S. Pat. No. 5,834,893 to Bulovic et al., U.S. Pat. No. 5,861,219 to Thompson et al., U.S. Pat. No. 5,904,916 to Tang et al., U.S. Pat. No. 5,986,401 to Thompson et al., U.S. Pat. No. 5,998,803 to Forrest et al., U.S. Pat. No. 6,013,538 to Burrows et al., U.S. Pat. No. 6,046,543 to Bulovic et al., U.S. Pat. No. 6,048,573 to Tang et al., U.S. Pat. No. 6,048,630 to Burrows et al., U.S. Pat. No. 6,066,357 to Tang et al., U.S. Pat. No. 6,125,226 to Forrest et al., U.S. Pat. No. 6,137,223 to Hung et al., U.S. Pat. No. 6,242,115 to Thompson et al., and U.S. Pat. No. 6,274,980 to Burrows et al.

In a typical matrix-address light-emitting display device, numerous light-emitting devices are formed on a single substrate and arranged in groups in a regular grid pattern. Activation may be by rows and columns, or in an active matrix with individual cathode and anode paths. OLEDs are often manufactured by first depositing a transparent electrode on the substrate, and patterning the same into electrode portions. The organic layer(s) is then deposited over the transparent electrode. A metallic electrode may be formed over the electrode layers. For example, in U.S. Pat. No. 5,703,436 to Forrest et al., incorporated herein by reference, transparent indium tin oxide (ITO) is used as the whole-injecting electrode, and a Mg- -Ag--ITO electrode layer is used for electron injection.

Modern chiral nematic liquid crystal materials usually include at least one nematic host combined with a chiral dopant. Suitable chiral nematic liquid crystal compositions preferably have a positive dielectric anisotropy and include chiral material in an amount effective to form focal conic and twisted planar textures. Chiral nematic liquid crystal materials are preferred because of their excellent reflective characteristics, bistability and gray scale memory. The chiral nematic liquid crystal is typically a mixture of nematic liquid crystal and chiral material in an amount sufficient to produce the desired pitch length.

Chiral nematic liquid crystal materials and cells, as well as polymer stabilized chiral nematic liquid crystals and cells, are well known in the art and described in, for example, U.S. Pat. No. 5,695,682, U.S. application Ser. No. 07/969,093, Ser. No. 08/057,662, Yang et al., Appl. Phys. Lett. 60(25) pp 3102-04 (1992), Yang et al., J. Appl. Phys. 76(2) pp 1331 (1994), published International Patent Application No. PCT/US92/09367, and published International Patent Application No. PCT/US92/03504, all of which are incorporated herein by reference.

Suitable commercial nematic liquid crystals include, for example, E7, E48, E44, E31, E80, TL202, TL203, TL204 and TL205 manufactured by E. Merck. The chiral nematic material may comprise, for example, one or more of the following materials obtained from Merck Ltd.: BL061, BL100, BL101, BL087, BL118, and BL036. Although nematic liquid crystals having positive dielectric anisotropy, and especially cyanobiphenyls, are preferred, virtually any nematic liquid crystal known in the art, including those having negative dielectric anisotropy, may be suitable for use with the invention. Chiral nematic liquid crystal materials may be Merck BL112, BL126, BL-03, BL-048 or BL-033, which are available from EM Industries of Hawthorne, N.Y. Other suitable materials may include ZLI-3308, ZLI-3273, ZLI-5048-000, ZLI-5049-100, ZLI-5100-100, ZLI-5800-000 and MLC-6041-100. Other light reflecting or diffusing modulating, electrically operated materials may also be coated, such as a micro-encapsulated electrophoretic material in oil. Examples of nematic hosts are mixtures containing 5CB or MBBA.

The present invention may employ, as a light-modulating layer, chiral-nematic liquid-crystal compositions dispersed in a continuous matrix. Such materials are referred to as “polymer-dispersed liquid crystal” materials or “PDLC” materials. Such materials may be made by a variety of methods. For example, Doane et al. (Applied Physics Letters 48, 269 (1986)) disclose a PDLC comprising approximately 0.4 μm droplets of nematic liquid crystal 5CB in a polymer binder. A phase separation method is used for preparing the PDLC. A solution containing monomer and liquid crystal is filled in a display cell and the material is then polymerized. Upon polymerization, the liquid crystal becomes immiscible and nucleates to form droplets. West et al. (Applied Physics Letters 63, 1471 (1993)) disclose a PDLC comprising a chiral nematic mixture in a polymer binder. Once again, a phase separation method is used for preparing the PDLC. The liquid-crystal material and polymer (a hydroxy functionalized polymethylmethacrylate) along with a cross-linker for the polymer are dissolved in a common organic solvent toluene and coated on an indium tin oxide (ITO) support. A dispersion of the liquid-crystal material in the polymer binder is formed upon evaporation of toluene at high temperature. The phase separation methods of Doane et al. and West et al. require the use of organic solvents that may be objectionable in certain manufacturing environments.

The liquid crystalline material may be made by methods known to those of skill in the art, such as an emulsification method or a phase separation method. In a preferred embodiment, the liquid crystalline material may be fabricated using limited coalescence processing to form uniformly sized emulsions of liquid crystalline material. Such methods are disclosed in U.S. patent application Ser. No. 10/095,379 to Stephenson, filed Mar. 12, 2002, titled “A Method Of Making A Coated Polymer-Dispersed Electro-Optical Fluid And Sheets Formed Thereby, hereby incorporated by reference in its entirety. This may be done by homogenizing the liquid crystalline material in the presence of finely divided silica, a coalescence limiting material, such as LUDOX from Dupont Corporation. A promoter material may be added to the aqueous bath to drive the colloidal particles to the liquid-liquid interface. In a preferred embodiment, a copolymer of adipic acid and 2-(methylamino) ethanol may be used as the promoting agent in the water bath. The liquid crystal material may be dispersed using ultrasound to create liquid crystal domains below 1 micron in size. When the ultrasound energy is removed, the liquid crystal material coalesces into domains of uniform size. The ratio of smallest to largest domain size preferably varies by approximately 1:2. By varying the amount of silica and copolymer relative to the liquid crystalline material, uniform domain size emulsions of average diameters of approximately 1, 3, and, 8 microns may be produced, as determined by microscopy. These emulsions may be diluted in gelatin solution for subsequent coating.

Preferably, the domains are flattened spheres and have on average a thickness substantially less than their length, preferably at least 50% less. More preferably, the domains on average have a thickness (depth) to length ratio of 1:2 to 1:6. The flattening of the domains may be achieved by proper formulation and sufficiently rapid drying of the coating. The domains preferably have an average diameter of 2 to 30 microns. The imaging layer preferably has a thickness of 10 to 150 microns when first coated and 2 to 20 microns when dried.

The flattened domains of liquid crystal material may be defined as having a major axis and a minor axis. In a preferred embodiment of a display or display sheet, the major axis is larger in size than the cell (or imaging layer) thickness for a majority of the domains. Such a dimensional relationship is shown in U.S. Pat. No. 6,061,107, hereby incorporated by reference in its entirety.

In a preferred embodiment, the contrast of the display is maximized by the use of only a substantial monolayer of N*LC domains. The term “substantial monolayer” is defined herein to mean that, in a direction perpendicular to the plane of the display, there is no more than a single layer of domains sandwiched between the electrodes at most points of the display (or the imaging layer), preferably at 75 percent or more of the points (or area) of the display, most preferably at 90 percent or more of the points (or area) of the display. In other words, at most, only a minor portion (preferably less than 10 percent) of the points (or area) of the display has more than a single domain (two or more domains) between the electrodes in a direction perpendicular to the plane of the display, compared to the amount of points (or area) of the display at which there is only a single domain between the electrodes.

The amount of material needed for a monolayer can be accurately determined by calculation based on individual domain size, assuming a fully closed packed arrangement of domains. In practice, there may be imperfections in which gaps occur and some unevenness due to overlapping droplets or domains. On this basis, the calculated amount is preferably less than about 150 percent of the amount needed for monolayer domain coverage, preferably not more than about 125 percent of the amount needed for a monolayer domain coverage, more preferably not more than 110 percent of the amount needed for a monolayer of domains. Furthermore, improved viewing angle and broadband features may be obtained by appropriate choice of differently doped domains based on the geometry of the coated droplet and the Bragg reflection condition.

The liquid crystalline layer or layers may also contain other ingredients. For example, while color is introduced by the liquid crystal material itself, pleochroic dyes may be added to intensify or vary the color reflected by the cell. Similarly, additives such as fumed silica may be dissolved in the liquid crystal mixture to adjust the stability of the various chiral nematic textures. A dye in an amount ranging from about 0.25% to about 1.5% may also be used.

At least one curable conductive layer may be utilized with the present invention. For higher conductivities, the conductive layer may comprise a silver-based layer which contains silver only or silver containing a different element such as aluminum (Al), copper (Cu), nickel (Ni), cadmium (Cd), gold (Au), zinc (Zn), magnesium (Mg), tin (Sn), indium (In), tantalum (Ta), titanium (Ti), zirconium (Zr), cerium (Ce), silicon (Si), lead (Pb) or palladium (Pd). In a preferred embodiment, the conductive layer comprises at least one of gold, silver and a gold/silver alloy, for example, a layer of silver coated on one or both sides with a thinner layer of gold. See, Int. Publ. No. WO 99/36261 by Polaroid Corporation. In another embodiment, the conductive layer may comprise a layer of silver alloy, for example, a layer of silver coated on one or both sides with a layer of indium cerium oxide (InCeO). See U.S. Pat. No. 5,667,853, incorporated herein in by reference.

The conductive layer may be formed in a vacuum environment using materials such as aluminum, tin, silver, platinum, carbon, tungsten, molybdenum, or indium. Oxides of these metals may be used to darken patternable conductive layers. The metal material may be excited by energy from resistance heating, cathodic arc, electron beam, sputtering or magnetron excitation. There may also be more than one conductive layer.

A suitable material may include electrically modulated material disposed on a suitable support structure, such as on or between one or more electrodes. The term “electrically modulated material” as used herein is intended to include any suitable non-volatile material. Suitable materials for the electrically modulated material are described in U.S. patent application Ser. No. 09/393,553 and U.S. Provisional Patent Application Ser. No. 60/099,888, the contents of both applications are herein incorporated by reference.

The electrically modulated material may also be a printable, conductive ink having an arrangement of particles or microscopic containers or microcapsules. Each microcapsule contains an electrophoretic composition of a fluid, such as a dielectric or emulsion fluid, and a suspension of colored or charged particles or colloidal material. The diameter of the microcapsules typically ranges from about 30 to about 300 microns. According to one practice, the particles visually contrast with the dielectric fluid. According to another example, the electrically modulated material may include rotatable balls that can rotate to expose a different colored surface area, and which can migrate between a forward viewing position and/or a rear non-viewing position, such as gyricon. Specifically, gyricon is a material comprised of twisting rotating elements contained in liquid-filled spherical cavities and embedded in an elastomer medium. The rotating elements may be made to exhibit changes in optical properties by the imposition of an external electric field. Upon application of an electric field of a given polarity, one segment of a rotating element rotates toward, and is visible by an observer of the display. Application of an electric field of opposite polarity, causes the element to rotate and expose a second, different segment to the observer. A gyricon display maintains a given configuration until an electric field is actively applied to the display assembly. Gyricon particles typically have a diameter of about 100 microns. Gyricon materials are disclosed in U.S. Pat. No. 6,147,791, U.S. Pat. No. 4,126,854 and U.S. Pat. No. 6,055,091, the contents of which are herein incorporated by reference.

According to one practice, the microcapsules may be filled with electrically charged white particles in a black or colored dye. Examples of electrically modulated material and methods of fabricating assemblies capable of controlling or effecting the orientation of the ink suitable for use with the present invention are set forth in International Patent Application Publication Number WO 98/41899, International Patent Application Publication Number WO 98/19208, International Patent Application Publication Number WO 98/03896, and International Patent Application Publication Number WO 98/41898, the contents of which are herein incorporated by reference.

The electrically modulated material may also include material disclosed in U.S. Pat. No. 6,025,896, the contents of which are incorporated herein by reference. This material comprises charged particles in a liquid dispersion medium encapsulated in a large number of microcapsules. The charged particles can have different types of color and charge polarity. For example, white positively charged particles can be employed along with black negatively charged particles. The described microcapsules are disposed between a pair of electrodes, such that a desired image is formed and displayed by the material by varying the dispersion state of the charged particles. The dispersion state of the charged particles is varied through a controlled electric field applied to the electrically modulated material. According to a preferred embodiment, the particle diameters of the microcapsules are between about 5 microns and about 200 microns, and the particle diameters of the charged particles are between about one-thousandth and one-fifth the size of the particle diameters of the microcapsules.

Further, the electrically modulated material may include a thermo-chromic material. A thermo-chromic material is capable of changing its state alternately between transparent and opaque upon the application of heat. In this manner, a thermo-chromic imaging material develops images through the application of heat at specific pixel locations in order to form an image. The thermo-chromic imaging material retains a particular image until heat is again applied to the material. Since the rewritable material is transparent, UV fluorescent printings, designs and patterns underneath can be seen through.

The electrically modulated material may also include surface stabilized ferrroelectric liquid crystals (SSFLC). Surface stabilized ferroelectric liquid crystals confine ferroelectric liquid crystal material between closely-spaced glass plates to suppress the natural helix configuration of the crystals. The cells switch rapidly between two optically distinct, stable states simply by alternating the sign of an applied electric field.

Magnetic particles suspended in an emulsion comprise an additional imaging material suitable for use with the present invention. Application of a magnetic force alters pixels formed with the magnetic particles in order to create, update or change human and/or machine readable indicia. Those skilled in the art will recognize that a variety of bi-stable non-volatile imaging materials are available and may be implemented in the present invention.

The electrically modulated material may also be configured as a single color, such as black, white or clear, and may be fluorescent, iridescent, bioluminescent, incandescent, ultraviolet, infrared, or may include a wavelength specific radiation absorbing or emitting material. There may be multiple layers of electrically modulated material. Different layers or regions of the electrically modulated material display material may have different properties or colors. Moreover, the characteristics of the various layers may be different from each other. For example, one layer can be used to view or display information in the visible light range, while a second layer responds to or emits ultraviolet light. The non-visible layers may alternatively be constructed of non-electrically modulated material based materials that have the previously listed radiation absorbing or emitting characteristics. The electrically modulated material employed in connection with the present invention preferably has the characteristic that it does not require power to maintain display of indicia.

The curable material may comprise a dielectric material. A dielectric layer, for purposes of the present invention, is a layer that is not conductive or that blocks the flow of electricity. This dielectric material may include a UV curable, thermoplastic, screen printable material, such as Electrodag 25208 dielectric coating from Acheson Corporation. The dielectric material forms a nonconductive layer. This layer may include openings to define image areas, which are coincident with the openings. Since the image is viewed through a transparent substrate, the indicia are mirror-imaged.

The dielectric material may form an adhesive layer to subsequently bond a second electrode to the light modulating layer. Conventional lamination techniques involving heat and pressure are employed to achieve a permanent durable bond. Certain thermoplastic polyesters, such as VITEL 1200 and 3200 resins from Bostik Corp., polyurethanes, such as MORTHANE CA-100 from Morton International, polyamides, such as UNIREZ 2215 from Union Camp Corp., polyvinyl butyral, such as BUTVAR B-76 from Monsanto, and poly(butyl methacrylate), such as ELVACITE 2044 from ICI Acrylics Inc. may also provide a substantial bond between the electrically conductive and light-modulating layers.

The dielectric adhesive layer may be coated from common organic solvents at a dry thickness of one to three microns. The dielectric adhesive layer may also be coated from an aqueous solution or dispersion. Polyvinyl alcohol, such as AIRVOL 425 or MM-51 from Air Products, poly(acrylic acid), and poly(methyl vinyl ether/maleic anhydride), such as GANTREZ AN-119 from GAF Corp. can be dissolved in water, subsequently coated over the second electrode, dried to a thickness of one to three microns and laminated to the light-modulating layer. Aqueous dispersions of certain polyamides, such as MICROMID 142LTL from Arizona Chemical, polyesters, such as AQ 29D from Eastman Chemical Products Inc., styrene/butadiene copolymers, such as TYLAC 68219-00 from Reichhold Chemicals, and acrylic/styrene copolymers such as RayTech 49 and RayKote 234L from Specialty Polymers Inc. can also be utilized as a dielectric adhesive layer as previously described.

The typical curing process takes place in several steps: (a) initiation, (b) machine conveyance curing, and (c) wound roll curing. There are two primary methods to cure the coatings: actinic and thermal. In actinic curing, polymerization of prepolymeric inks with less than 10% volatiles is initiated by the application of electromagnetic energy. UV wavelengths at less than 386 nanometers are used for this process. Dosage limits are 100 to 700 mJ/cm² with 300 to 500 mJ/cm² preferred. Temperature and air flow are standard for one skilled in the art. UV curing is not complete, however, as additional time is required to fully complete the process. The web typically requires time in the wound roll, without lap-to-lap contact, to fully cure. Temperature limits may be 10 to 100° C. with 20 to 30° C. preferred. Humidity limits may be 0 to 90% with 40 to 60% preferred. Air flow limits may be 0 to 4000 fpm with 0 to 15 fpm preferred. The presence of any of a number of gases is useful to the process with air or nitrogen being preferred. It is understood by those of skill in the art of curing that the term “air flow” may also mean “gas flow”. In addition, the “flow” may be accomplished by a liquid.

Thermally curable solvent coatings rely on diffusion and convection to drive off volatiles that can be up to 75% of the total coating. Initiation and conveyance curing take place by the application of elevated temperature gas moving along or across the web. Air dryer technology is well known and standard practices exist for these processes. In the conventional wound roll, drying does not usually continue; however, when the layers are spaced so that lap-to-lap contact does not take place, drying can continue. Temperature limits are 20 to 100° C. with 70 to 90° C. preferred, humidity limits are 20 to 60% with 30 to 50% preferred, and air flow limits are 0 to 4000 fpm with 0 to 15 fpm preferred.

The LCD may also comprise other functional layers, including a conductive layer between the curable layers and the support and any of the layers described above as curable layers.

The LCD contains at least one conductive layer, which typically is comprised of a primary metal oxide. This conductive layer may comprise other metal oxides such as indium oxide, titanium dioxide, cadmium oxide, gallium indium oxide, niobium pentoxide and tin dioxide. See, Int. Publ. No. WO 99/36261 by Polaroid Corporation. In addition to the primary oxide such as ITO, the at least one conductive layer may also comprise a secondary metal oxide such as an oxide of cerium, titanium, zirconium, hafnium and/or tantalum. See, U.S. Pat. No. 5,667,853 to Fukuyoshi et al. (Toppan Printing Co.) Other transparent conductive oxides include, but are not limited to ZnO₂, Zn₂SnO₄, Cd₂SnO₄, Zn₂In₂O₅, MgIn₂O₄, Ga₂O₃—In₂O₃, or TaO₃. The conductive layer may be formed, for example, by a low temperature sputtering technique or by a direct current sputtering technique, such as DC-sputtering or RF-DC sputtering, depending upon the material or materials of the underlying layer. The conductive layer may be a transparent, electrically conductive layer of tin-oxide or indium-tin-oxide (ITO), or polythiophene. Typically, the conductive layer is sputtered onto the support to a resistance of less than 250 ohms per square. Alternatively, the conductive layer may be an opaque electrical conductor formed of metal such as copper, aluminum or nickel. If the conductive layer is an opaque metal, the metal may be a metal oxide to create a light absorbing conductive layer.

Indium tin oxide (ITO) is the preferred conductive material, as it is a cost effective conductor with good environmental stability, up to 90% transmission, and down to 20 ohms per square resistivity. An exemplary preferred ITO layer has a transmittance, % T, greater than or equal to 80% in the visible region of light, that is, from greater than 400 nm to 700 nm, so that the film will be useful for display applications. In a preferred embodiment, the conductive layer comprises a layer of low temperature ITO, which is polycrystalline. The ITO layer is preferably 10-120 nm in thickness, or 50-100 nm thick to achieve a resistivity of 20-60 ohms/square on plastic. An exemplary preferred ITO layer is 60-80 nm thick.

The conductive layer is preferably patterned. The conductive layer is preferably patterned into a plurality of electrodes. The patterned electrodes may be used to form a LCD device. In another embodiment, two conductive substrates are positioned facing each other and chiral nematic liquid crystals are positioned therebetween to form a device. The patterned ITO conductive layer may have a variety of dimensions. Exemplary dimensions may include line widths of 10 microns, distances between lines, that is, electrode widths, of 200 microns, depth of cut, that is, thickness of ITO conductor, of 100 nanometers. ITO thicknesses on the order of 60, 70, and greater than 100 nanometers are also possible.

The conductive layer may be patterned by irradiating the multilayered conductor structure with ultraviolet radiation so that portions of the conductive layer are ablated therefrom. It is also known to employ an infra-red (IR) fiber laser for patterning a metallic conductive layer overlying a plastic film, directly ablating the conductive layer by scanning a pattern over the conductor/film structure. See: Int. Publ. No. WO 99/36261 and “42.2: A New Conductor Structure for Plastic LCD Applications Utilizing ‘All Dry’ Digital Laser Patterning,” 1998 SID International Symposium Digest of Technical Papers, Anaheim, Calif., May 17-22, 1998, no. VOL. 29, May 17, 1998, pages 1099-1101, both incorporated herein by reference.

One type of functional layer may be a color contrast layer. Color contrast layers may be radiation reflective layers or radiation absorbing layers. In some cases, the rearmost substrate of each display may preferably be painted black. The black paint absorbs infrared radiation that reaches the back of the display. In the case of the stacked cell display, the contrast may be improved by painting the back substrate of the last visible cell black. The paint is preferably transparent to infrared radiation. This effectively provides the visible cell with a black background that improves its contrast, and yet, does not alter the viewing characteristics of the infrared display. Paint such as black paint, which is transparent in the infrared region, is known to those skilled in the art. For example, many types of black paint used to print the letters on computer keys are transparent to infrared radiation. In one embodiment, a light absorber may be positioned on the side opposing the incident light. In the fully evolved focal-conic state, the chiral nematic liquid crystal is transparent, passing incident light, which is absorbed by the light absorber to create a black image. Progressive evolution of the focal-conic state causes a viewer to perceive a reflected light that transitions to black as the chiral nematic material changes from planar state to a focal conic state. The transition to the light transmitting state is progressive, and varying the low voltage time permits variable levels of reflection. These variable levels may be mapped out to corresponding gray levels, and when the field is removed, the light-modulating layer maintains a given optical state indefinitely. This process is more fully discussed in U.S. Pat. No. 5,437,811, incorporated herein by reference.

The color contrast layer may also be other colors. In another embodiment, the dark layer comprises milled non-conductive pigments. The materials are milled below I micron to form “nano-pigments”. Such pigments are effective in absorbing wavelengths of light in very thin or “sub micron” layers. In a preferred embodiment, the dark layer absorbs all wavelengths of light across the visible light spectrum, that is from 400 nanometers to 700 nanometers wavelength. The dark layer may also contain a set or multiple pigment dispersions. For example, three different pigments, such as a Yellow pigment, milled to a median diameter of 120 nanometers, a magenta pigment, milled to a median diameter of 210 nanometers, and a cyan pigment, such as Sunfast® Blue Pigment 15:4 pigment, milled to a median diameter of 10 nanometers, are combined. A mixture of these three pigments produces a uniform light absorption across the visible spectrum. Suitable pigments are readily available and are designed to be light absorbing across the visible spectrum. In addition, suitable pigments are inert and do not carry electrical fields.

Suitable pigments used in the color contrast layer may be any colored materials, which are practically insoluble in the medium in which they are incorporated. The preferred pigments are organic, in which carbon is bonded to hydrogen atoms and at least one other element such as nitrogen, oxygen and/or transition metals. The hue of the organic pigment is primarily defined by the presence of one or more chromophores, a system of conjugated double bonds in the molecule, which is responsible for the absorption of visible light. Suitable pigments include those described in Industrial Organic Pigments: Production, Properties, Applications by W. Herbst and K. Hunger, 1993, Wiley Publishers. These include, but are not limited to, Azo Pigments such as monoazo yellow and orange, diazo, naphthol, naphthol reds, azo lakes, benzimidazolone, diazo condensation, metal complex, isoindolinone and isoindolinic, polycyclic pigments such as phthalocyanine, quinacridone, perylene, perinone, diketopyrrolo-pyrrole, and thioindigo, and anthriquinone pigments such as anthrapyrimidine, triarylcarbonium and quinophthalone.

The functional layer may comprise a protective layer or a barrier layer. A preferred barrier layer may act as a gas barrier or a moisture barrier and may comprise SiOx, AlOx or ITO. The protective layer, for example, an acrylic hard coat, functions to prevent laser light from penetrating to functional layers between the protective layer and the support, thereby protecting both the barrier layer and the support. The functional layer may also serve as an adhesion promoter of the conductive layer to the support. Protective layers may be applied in any of a number of well-known techniques, such as dip coating, rod coating, blade coating, air knife coating, gravure coating and reverse roll coating, extrusion coating, slide coating, curtain coating, and the like. The lubricant particles and the binder are preferably mixed together in a liquid medium to form a coating composition. The liquid medium may be a medium such as water or other aqueous solutions in which the hydrophilic colloid are dispersed, with or without the presence of surfactants.

Once the interleaving and coated support have been wound into a roll, various process steps may be taken while in this format. The wound roll package may be shipped in this state. The interlayer pressure, between laps in the roll, allows the wound roll package to remain intact and not lose integrity or fall apart. The wound roll package may be unwound at a post-processing station for any variety of process steps. This wound roll package allows for easy handling, shipping, storage, while not destroying the coatings or scratching the coated surfaces and at the same time allowing for post processing curing to occur.

The wound roll package may be made of HDPE (high density polyethylene) conductive material. The wound roll package is designed to protect rolls in transportation through all stages and manufacturing sites of the LCD manufacturing process. This would include post slitting of the wide roll, coating of the conductive layer, laser etching, liquid crystal coating, and printing. The wound roll package is preferably designed to transport one roll per box, core supported in a horizontal orientation to protect the roll against physical damage (core impressions, telescoping, edge and damage). The wound roll package is preferably designed to protect the roll during all stages of the manufacturing process against physical contamination (dirt and all forms of particulate matter). The wound roll package is also preferably designed to maintain the internal moisture content of the roll at 50% RH. The wound roll package may also be designed to be stacked horizontally on transport carts or pallets.

The wound roll package may be designed to integrate with existing material handling equipment that supports the wound roll package and the roll horizontally by the core during all roll transfers in the LCD manufacturing process. In one embodiment, illustrated in FIG. 6, the wound roll package 24 comprises 3 parts, the box (body) 26, removable end support 28, and optional plug 30. The removable end support 28 and body 26 may have integrated core supports 32 and openings 80 to accommodate material handling equipment. An optional plug 30 may be placed in opening 80 in the removable end support 28 (also commonly referred to as a lid) during cart or pallet transport to protect against physical contamination and maintain internal moisture content of the roll located in the wound roll package at 50% RH. The plug 30 may be crowned to prevent the wound roll package from being accidentally stacked on its ends. A wound, coated support 82, which has been wound on core 34 is placed on core support 32, fitted into wound roll package 24, and optional plugs 30 inserted into opening 80 in the core support 82.

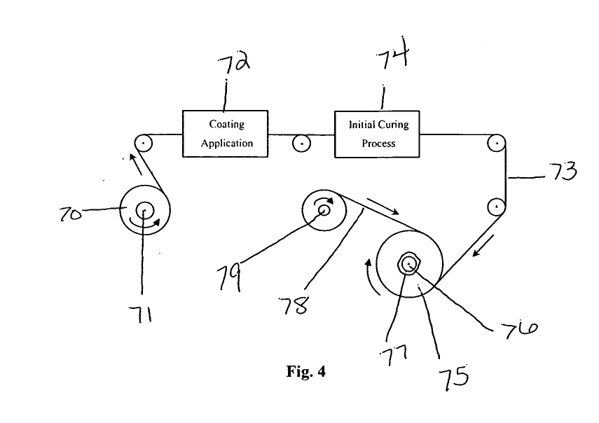

In simplest form, the method provides unwinding, coating application, interleaving application and winding of the coated support. An exemplary process design is illustrated in FIG. 4, which includes an optional step for initiating curing. The uncoated support 70 is unwound by unwinder 71 and conveyed to a station where the coating application 72 occurs. Once coated, the support is conveyed to a cure initiation station 74, at which point curing begins. However, curing is completed in the wound roll. The coated support 73 is then conveyed to the winder 76, where the interleaving material 78 is unwound by secondary unwinder 79 and applied at the same time that the support is wound onto a core 77. The coated, wound roll 75 may then be subjected to other process steps such as curing, further winding or rewinding, shipping, handling, or any other suitable process steps.

As previously mentioned, in simplest form, the interleaving material is attached to a windable support bearing a conventional polymer dispersed light-modulating material. In a preferred embodiment, a support, wound on a core, is coated with a curable layer. The interleaving material is then applied to the support so as not to be in contact with the curable layer. Typically, this is accomplished by applying the interleaving material to the edges of coated sheet. The support is then wound into a roll. The resulting wound roll has a gap between wound layers approximately equal to the thickness of the interleaving material.

The interleaving material may be applied to the support before, during or after the applications of the coating to the support. In addition, the interleaving material may be applied to both sides of the roll, that is, applied to the coated side of the support, as well as the side of the support opposite the coated side. In some instances, both sides of the support may be coated. It is intended that this method will be applicable to any width of support. However when the support is very wide, at least a third strip of interleaving may be needed to provide support in the center of the roll. This is needed when the stiffness of the web is insufficient to carry the load caused by the weight of the support across the width.

The rolls may be wound at various winding tensions. Winding the support and interleaving at too high a tension may cause the interleaving to be crushed and inadvertently minimize the gap, which the interleaving is intended to create. Contrarily, when the coated support and the interleaving are not wound at high enough tensions, the produced wound roll may not have enough integrity to remain in a roll form and could clock spring, telescope or dish, common roll winding defects. The interleaving material provides support around the roll in the radial and axial direction. Tension ranges for winding may vary depending on the usage of the coated support and the interleaving embodiment selected. The interleaving material is desirably capable of being wound at the same tension as the support material. For example, if a spiral interleaving format is selected, the tension may be anything greater than 0. If a Velcro interleaving material is selected, typical tansion ranges may vary from 17.5 to 1752 Newtons per linear meter (0.1 to 10 pounds per linear inch) and winding speed may vary from 0.03 to 152 meters per minute (0.1 to 500 feet per minute).

In a preferred embodiment, the present invention is used to produce a liquid crystalline display. For example in liquid crystalline mixtures that are used in selectively reflecting chiral nematic displays, the pitch has to be selected such that the maximum of the wavelength reflected by the chiral nematic helix is in the range of visible light. Another possible application is polymer films with a chiral liquid crystalline phase for optical elements, such as chiral nematic broadband polarizers or chiral liquid crystalline retardation films. Among these are active and passive optical elements or color filters and liquid crystal displays, for example STN, TN, AMD-TN, temperature compensation, polymer free or polymer stabilized chiral nematic texture (PFCT, PSCT) displays. Possible display industry applications include ultralight, flexible, and inexpensive displays for notebook and desktop computers, instrument panels, video game machines, videophones, mobile phones, hand-held PCs, PDAs, e-books, camcorders, satellite navigation systems, store and supermarket pricing systems, highway signs, informational displays, smart cards, toys, and other electronic devices. The present invention may also be used in the production of other products, for example, sensors, medical test films, solar cells, fuel cells, to name a few.

### EXAMPLES

The following examples are provided to illustrate the invention.

### Example 1

A Velcro® fastener material was used as the interleaving material in this experiment. This material came in 1″ wide strips by 25 yards in length. The Velcro® fastener material was obtained with an adhesive backing on it.

The Velcro® fastener material was attached to the support, one strip at a time, along each edge. The support was threaded up on a respooler. The respooler was equipped with a winder, unwinder and a separate braked unwind. One roll of Velcro® fastener material was mounted on the braked unwind. The respooler was started and the winder began to wind a roll. As this was occurring, the backing of the Velcro® fastener material was peeled off and the adhesive side of the Velcro® material was applied to the winding support. This was done until the Velcro® fastener material spool was empty. Once the Velcro® fastener material spool was empty, the respooler was stopped and a new Velcro® fastener material spool was mounted to the unwind brake and the process continued until a 225′ roll had been completed. Please note that only one edge of the support had the Velcro® fastener material applied, or, in other words, the Velcro® fastener interleaving was supporting only one edge of the support. By applying the Velcro® fastener material to only one edge of the support, continuous support was seen through the roll in the form of a gap. Once one edge of the support had Velcro® fastener material applied, the same procedure was used to apply the second edge. The roll was now ready to be wound under differing tensions to determine the roll integrity, the qualitative amount of air that could flow through the roll, and to ensure an interlayer gap was being provided.

Interlayer Gap Results—5″ Wide Roll:

After the two strips of Velcro® fastener material were applied to both edges of the support, the support was tested for an interlayer gap. This was a qualitative test, not a quantitative test. A double-sided tape was applied to the center of the support, not in contact with the interleaving material, and the backing was removed from the side of the tape not in contact with the support, leaving a sticky side of the tape exposed. The roll was then wound with the tape on it under varying winding tension. Once the roll was wound, it was immediately unwound and checked for any adhesion between the exposed tape surface and the support wound over the tape. After unwinding the entire roll, no interlayer contact was detected. The Velcro® fastener material interleaving material provided a continuous support around the roll and created a uniform interlayer gap between adjacent laps.

Air Flow Results—5″ Wide Roll:

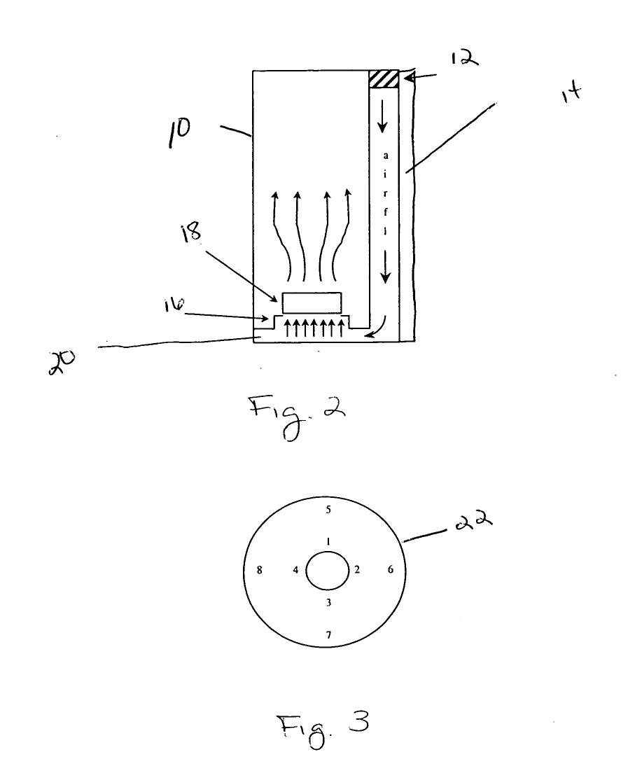

A heated enclosure, illustrated in FIG. 2, was used to perform air flow analysis. The heated enclosure was an insulated container 10 with attached fan 12 and heaters 14. The fan blew heated air into the storage chamber at approximately 100 ft³/min. A shelving unit 16 was fabricated to fit inside the enclosure so that wound roll 18 could be placed on thereon and an even flow of air would blow through the roll. Please see FIG. 2 for the experimental setup.

The rolls were wound at various winding tensions and directly placed into the enclosure for air flow analysis. Once the roll was placed on the shelf, the fan was turned on and the air velocity was measured through the roll. The backpressure, P_{B}, was measured at back pressure measurement point 20, along with the velocity of air flow at 8 discrete points on the roll 22, as shown in FIG. 3.

Please see that following data for the air flow experiments:

| Tension = 1.5 lb | | Tension = 2.0 lb | | Tension = 3.0 lb | |
|---|---|---|---|---|---|
| Pressure Drop = | | Pressure Drop = | | Pressure Drop = | |
| 0.025″ H₂O | | 0.020″ H₂O | | 0.025″ H₂O | |
| Roll Diameter = 19.5″ | | Roll Diameter = 19.3″ | | Roll Diameter = 19.0″ | |
| Avg. Gap = n/a | | Avg. Gap = 0.075″ | | Avg. Gap = 0.070″ | |
| | Velocity | | Velocity | | Velocity |
| Location | (fpm) | Location | (fpm) | Location | (fpm) |
| 1 | 70 | 1 | 65 | 1 | 70 |
| 2 | 75 | 2 | 60 | 2 | 67 |
| 3 | 66 | 3 | 60 | 3 | 65 |
| 4 | 75 | 4 | 68 | 4 | 72 |
| 5 | 63 | 5 | 55 | 5 | 60 |
| 6 | 65 | 6 | 55 | 6 | 60 |
| 7 | 59 | 7 | 50 | 7 | 60 |
| 8 | 60 | 8 | 58 | 8 | 62 |

| | |
|---|---|
| Tension = 4.0 lb | Tension = 10 lb |
| Pressure Drop = 0.025″ | Pressure Drop = 0.025″ |
| H₂O | H₂O |
| Roll Diameter = 18.8″ | Roll Diameter = N.A. |
| Avg. Gap = 0.065″ | Avg. Gap = 0.055″ |

| Location | Velocity (fpm) | Location | Velocity (fpm) |
|---|---|---|---|
| 1 | 70 | 1 | 65 |
| 2 | 70 | 2 | 62 |
| 3 | 69 | 3 | 60 |
| 4 | 72 | 4 | 70 |
| 5 | 60 | 5 | 56 |
| 6 | 60 | 6 | 60 |
| 7 | 58 | 7 | 55 |
| 8 | 60 | 8 | 60 |

From the data, it can be seen that the pressure drops across the roll range from 4.92×10⁻⁵ atm to 6.14×10⁻⁵ atm (7.23×10⁻⁴ psi to 9.03×10⁻⁴ psi). Since the pressure drop is extremely low, it is assumed that the Velcro® fastener interleaving allows air to pass freely through the roll and provides continuous support.

Interlayer Gap Results—16″ Wide Roll:

Similarly to the 5″ wide interlayer gap test, the Velcro® fastener material strips were attached to a 16″ wide roll. One edge of the fastener material was applied at a time. In the 5″ wide experimentation, when one edge of the Velcro® fastener material was applied, an interlayer gap was supported by the Velcro® fastener material across 5″. Similar results were seen in the 16″ support, however the interlayer gap was not as uniform as the 5″ wide experiments, due to the weight of the 16″ support.

Interlayer Gap Results—16″ Wide Roll:

After the two strips of Velcro® fastener material were applied to both edges of the support, the roll was tested for an interlayer gap. This was a qualitative test, not a quantitative test. The roll, 75 ft. in length, was wound with the tape on it under 8 lbs of winding tension. Initially, double-sided tape was going to be applied to the support to determine whether interlayer contact occurred. However, after visually inspecting the roll, no double-sided tape was needed. From the visual inspection, the interlayer gap could be clearly seen through the roll, when held up to a light source. Each lap was separated by a consistent and uniform gap throughout the roll. The Velcro® fastener material provides a uniform gap across the width of the support. The gap does not appear to vary greatly in the radial or axial direction of the roll.

After reviewing the experimentation data for the 5″ wide and 16″ wide tests, it is apparent that Velcro® fastener material provides the desired gap throughout the entire roll, axially and radially. There is no contact between adjacent laps of the wound support. Secondly, after running air flow experimentation, it is apparent that Velcro® fastener material allows air to be blown through the roll with a minimal pressure drop.

### Example 2

A liquid crystal display is prepared as follows: A 125 micron polyethylene terephthalate support is coated with a layer of ITO (300 ohm per square resistively) forming the first electrode. The ITO is laser etched with thin lines to electrically separate rows in the first electrode. Each row corresponds to an individual character in the display. An imageable layer containing gelatin and droplets of cholesteric liquid crystal is coated on the ITO layer. A color contrasting black layer containing gelatin and cyan, magenta, yellow, and black pigments is coated on the imageable layer. Thin bands of the two coated layers are removed along on edge of the display perpendicular to the laser etch lines. This exposes the ITO along the edge of the display to allow electrical contact to the first electrode. A conductive UV curable ink is then screen printed on the color contrasting layer, exposed to UV radiation and wound on a spool with interleaving in accordance with the current invention, as outlined in example 1. The screen patterns the conductive ink to form segments of characters in a seven-segment display. These segments form the second electrode. After curing is complete, the material is unwound and screen printed with a UV curable dielectric ink, exposed to UV radiation and wound on a spool with interleaving in accordance with the current invention as outlined in example 1. The screen patterns the dielectric to surround and cover the conductive segments leaving only a small via hole over each segment. The via-hole allows subsequent electrical contact. The dielectric ink also covers the exposed ITO except for via holes that allow subsequent electrical contact to the first electrode. After curing is complete the material is unwound and again screen printed with a second layer of UV curable dielectric, exposed to UV radiation and wound on a spool with interleaving in accordance with the current invention, as outlined in example 1. The screen has the same pattern as the first pass of dielectric ink. After curing is complete the material is unwound and screen printed with UV curable conductive ink, exposed to UV radiation and wound on a spool with interleaving in accordance with the current invention, as outlined in example 1. The screen patterns the conductive ink to form electrical traces and contact pads. The contact pads are used to connect the display to external drive electronics. The traces carry electrical signals from the contact pads to the individual segments making contact to the second electrode through the via-holes in the dielectric layers. Pads also cover areas of exposed ITO through via-holes in the dielectric layers to make contact with the first electrode.

The invention has been described in detail with particular reference to certain preferred embodiments thereof, but it will be understood that variations and modifications can be effected within the spirit and scope of the invention.

1. A method of interleaving a support comprising providing a support, applying at least one curable material to a side of said support, applying an interleaving material to said support so as not to be in contact with said curable material applied to said side of said support, and winding said support to produce a continuous gap between the side of said support opposite said side of said support coated with said curable material and said curable material.

2. The method of claim 1 wherein said support comprises a windable support.

3. The method of claim 1 wherein said support comprises a flexible support.

4. The method of claim 1 wherein said support comprises at least one member selected from the group consisting of polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl (x-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ether ketone) (PEEK), poly(ether ketone) (PEK), poly(ethylene tetrafluoroethylene) fluoropolymer (PETFE), and poly(methyl methacrylate) acrylate/methacrylate copolymers (PMMA).

5. The method of claim 1 wherein said support comprises polyethylene terephthalate (PET).

6. The method of claim 1 wherein said support comprises polyethylene naphthalate (PEN).

7. The method of claim 1 wherein said support comprises polyester.

8. The method of claim 1 wherein said support comprises polyimide.

9. The method of claim 1 wherein said support comprises cellulose acetate.

10. The method of claim 1 wherein said support comprises aliphatic polyolefin.

11. The method of claim 10 wherein said aliphatic polyolefin comprises high density polyethylene (HDPE), low density polyethylene (LDPE), polypropylene, and oriented polypropylene (OPP).

12. The method of claim 1 wherein said support is greater than 3 microns in thickness.

13. The method of claim 1 wherein said support is from 50 to 250 microns in thickness.

14. The method of claim 1 wherein said support further comprises a hard coating.

15. The method of claim 1 further comprising applying said support to a second support.

16. The method of claim 1 wherein said support has been previously wound onto a core.

17. The method of claim 1 wherein said curable material comprises electrically modulated material.

18. The method of claim 17 wherein said electrically modulated material comprises a thermo-chromic material.

19. The method of claim 17 wherein said electrically modulated material comprises light modulating material.

20. The method of claim 19 wherein said light modulating material comprises liquid crystalline material.

21. The method of claim 20 wherein said liquid crystalline material comprises chiral nematic liquid crystalline materials.

22. The method of claim 1 wherein said curable material comprises a conductive material.

23. The method of claim 22 wherein said conductive material comprises conductive ink.

24. The method of claim 23 wherein said conductive ink is silver based.

25. The method of claim 23 wherein said conductive ink comprises microcapsules.

26. The method of claim 23 wherein said conductive ink comprises an arrangement of particles.

27. The method of claim 26 wherein said particles comprise rotatable balls that can rotate to expose a different colored surface area, and which can migrate between a forward viewing position and/or a rear non-viewing position.

28. The method of claim 1 wherein said curable material comprises color contrast materials.

29. The method of claim 1 wherein said curable material comprises dielectric materials.

30. The method of claim 1 wherein said curable material comprises barrier layers.

31. The method of claim 1 wherein said at least one curable layer is from 10 to 70 microns in thickness.

32. The method of claim 1 wherein said support and said at least one curable layer have a total thickness of from 60 to 300 microns.

33. The method of claim 1 wherein said curable material is cured by the application of light.

34. The method of claim 33 wherein said light comprises ultraviolet light.

35. The method of claim 33 wherein said light comprises visible light.

36. The method of claim 33 wherein said light comprises infrared light.

37. The method of claim 1 wherein said curable material is cured by the application of heat.

38. The method of claim 1 wherein said curable material is cured by the application of air flow.

39. The method of claim 1 wherein said curable material is cured by chemical reaction.

40. The method of claim 39 wherein said chemical reaction comprises cross-linking polymerizations.

41. The method of claim 1 wherein said interleaving material comprises a continuous roll.

42. The method of claim 1 wherein said interleaving material comprises a strip applied along at least one edge of said support.

43. The method of claim 1 wherein said interleaving material comprises a strip applied along at least two edges of said support.

44. The method of claim 1 wherein said interleaving material comprises of a flexible material.

45. The method of claim 44 wherein said flexible material comprises open celled foam.

46. The method of claim 44 wherein said flexible material comprises Velcro® fastener material.

47. The method of claim 44 wherein said flexible material comprises mesh.

48. The method of claim 1 wherein said interleaving material has a thickness of from 0.762 to 2.286 mm.

49. The method of claim 1 wherein said interleaving material has a thickness of from 1.016 to 2.032 mm.

50. The method of claim 1 wherein said interleaving material further comprises adhesive backing.

51. The method of claim 1 wherein said gap is greater than 75 microns.

52. The method of claim 1 wherein said gap measures from 0.127 to 3.175 mm.

53. The method of claim 1 wherein said winding is continuous.

54. The method of claim 1 wherein said winding has a winding tension of from 17.5 to 1752 Newtons per linear meter.

55. The method of claim 1 wherein said winding has a speed of from 0.03 to 152 meters per minute.

56. The method of claim 1 further comprising curing said curable coating

57. The method of claim 56 further comprising patterning said cured coating.

58. The method of claim 1 wherein said gap provides air flow therethrough from 0 to 269 mpm in velocity.

59. A roll of liquid crystalline material comprising a support having thereon a curable material and an interleaving material, wherein said interleaving material is not in contact with said curable material on said support, wherein said support is wound to form a roll.

60. The roll of liquid crystalline material of claim 59 wherein said support comprises a windable support.

61. The roll of liquid crystalline material of claim 59 wherein said support comprises a flexible support.

62. The roll of liquid crystalline material of claim 59 wherein said support comprises at least one member selected from the group consisting of polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl(x-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ether ketone) (PEEK), poly(ether ketone) (PEK), poly(ethylene tetrafluoroethylene) fluoropolymer (PETFE), and poly(methyl methacrylate) acrylate/methacrylate copolymers (PMMA).

63. The roll of liquid crystalline material of claim 59 wherein said support comprises polyethylene terephthalate (PET).

64. The roll of liquid crystalline material of claim 59 wherein said support comprises polyethylene naphthalate (PEN).

65. The roll of liquid crystalline material of claim 59 wherein said support comprises polyester.

66. The roll of liquid crystalline material of claim 59 wherein said support comprises polyimide.

67. The roll of liquid crystalline material of claim 59 wherein said support comprises cellulose acetate.

68. The roll of liquid crystalline material of claim 59 wherein said support comprises aliphatic polyolefin.

69. The roll of liquid crystalline material of claim 68 wherein said aliphatic polyolefin comprises high density polyethylene (HDPE), low density polyethylene (LDPE), polypropylene, and oriented polypropylene (OPP).

70. The roll of liquid crystalline material of claim 59 wherein said support is greater than 3 microns in thickness.

71. The roll of liquid crystalline material of claim 59 wherein said support further comprises a hard coating.

72. The roll of liquid crystalline material of claim 59 wherein said support has been previously wound onto a core.

73. The roll of liquid crystalline material of claim 59 wherein said curable material comprises electrically modulated material.

74. The roll of liquid crystalline material of claim 73 wherein said electrically modulated material comprises a thermo-chromic material.

75. The roll of liquid crystalline material of claim 73 wherein said electrically modulated material comprises light modulating material.

76. The roll of liquid crystalline material of claim 75 wherein said light modulating material comprises liquid crystalline material.

77. The roll of liquid crystalline material of claim 76 wherein said liquid crystalline material comprises chiral nematic liquid crystalline materials.

78. The roll of liquid crystalline material of claim 59 method of claim 1 wherein said curable material comprises a conductive material.

79. The roll of liquid crystalline material of claim 78 wherein said conductive material comprises conductive ink.

80. The roll of liquid crystalline material of claim 79 wherein said conductive ink is silver based.

81. The roll of liquid crystalline material of claim 79 wherein said conductive ink comprises microcapsules.

82. The roll of liquid crystalline material of claim 79 wherein said conductive ink comprises an arrangement of particles.

83. The roll of liquid crystalline material of claim 83 wherein said particles comprise rotatable balls that can rotate to expose a different colored surface area, and which can migrate between a forward viewing position and/or a rear non-viewing position.

84. The roll of liquid crystalline material of claim 59 wherein said curable material comprises color contrast materials.

85. The roll of liquid crystalline material of claim 59 wherein said curable material comprises dielectric materials.

86. The roll of liquid crystalline material of claim 59 wherein said curable material comprises barrier layers.

87. The roll of liquid crystalline material of claim 59 wherein said curable material is cured by the application of light.

88. The roll of liquid crystalline material of claim 87 wherein said light comprises ultraviolet light.

89. The roll of liquid crystalline material of claim 87 wherein said light comprises visible light.

90. The roll of liquid crystalline material of claim 87 wherein said light comprises infrared light.

91. The roll of liquid crystalline material of claim 59 wherein said curable material is cured by the application of heat.

92. The roll of liquid crystalline material of claim 59 wherein said curable material is cured by the application of air flow.

93. The roll of liquid crystalline material of claim 59 wherein said curable material is cured by chemical reaction.

94. The roll of liquid crystalline material of claim 93 wherein said chemical reaction comprises cross-linking polymerizations.

95. The roll of liquid crystalline material of claim 59 wherein said interleaving material comprises a strip applied along at least one edge of said support.

96. The roll of liquid crystalline material of claim 59 wherein said interleaving material comprises of a flexible material.

97. The roll of liquid crystalline material of claim 96 wherein said flexible material comprises open celled foam.

98. The roll of liquid crystalline material of claim 96 wherein said flexible material comprises Velcro® fastener material.

99. The roll of liquid crystalline material of claim 96 wherein said flexible material comprises mesh.

100. The roll of liquid crystalline material of claim 59 wherein said interleaving material has a thickness of from 0.762 to 2.286 mm.

101. The roll of liquid crystalline material of claim 59 wherein said interleaving material has a thickness of from 1.016 to 2.032 mm.

102. The roll of liquid crystalline material of claim 59 wherein said interleaving material further comprises adhesive backing.

103. The roll of liquid crystalline material of claim 59 wherein said gap is greater than 75 microns.

104. The roll of liquid crystalline material of claim 59 wherein said gap measures from 0.127 to 3.175 mm.

105. The roll of liquid crystalline material of claim 59 wherein said gap provides air flow therethrough from 0 to 269 mpm in velocity.
